(19) United States
(12) Patent Application Publication
(10) Pub. No.: US 2011/0176521 A1
(43) Pub. Date: Jul. 21, 2011

(54) APPARATUS AND METHOD OF TRANSMITTING PACKET OF NODE IN WIRELESS SENSOR NETWORK

(76) Inventors: Hyeon Park, Daejeon (KR); Young-Hwan Ham, Daejeon (KR); Sang-Joon Park, Daejeon (KR)

(21) Appl. No.: 13/120,059

(22) PCT Filed: May 12, 2009
(86) PCT No.: PCT/KR09/02484

§ 371 Date: Mar. 21, 2011

(30) Foreign Application Priority Data
Sep. 23, 2008 (KR) 10-2008-0093391

(51) Int. Cl. H04W 28/14; H04W 72/12

(52) U.S. Cl. 370/336; 370/328

(57) ABSTRACT

Provided is an apparatus and method of transmitting a packet of a node in a wireless sensor network. The apparatus includes a plurality of priority queues, wherein packets to be transmitted to neighboring nodes are stored in each of the priority queues according to transmission priority, and the packets are transmitted according to the priority of each priority queue. Accordingly, a delay of a packet that requires real-time transmission is minimized by using priority queues in a node.

### CROSS-REFERENCE TO RELATED PATENT APPLICATION

This application claims the benefit of Korean Patent Application No. 10-2008-0093391, filed on Sep. 23, 2008, in the Korean Intellectual Property Office, the disclosure of which is incorporated herein in its entirety by reference.

### BACKGROUND OF THE INVENTION

1. Field of the Invention

The present invention relates to an apparatus and method of transmitting a packet of a node in a wireless sensor network, and more particularly, to an apparatus and method of transmitting a packet of a node in a wireless sensor network, which minimizes delay of a packet that requires real-time transmission by using priority queues in the node, and realizing reliable routing by using queue information of a neighboring node.

2. Description of the Related Art

A sensor network is used for various application services, such as industrial services, health and medical services, energy services, parking management services, and national defense boundary observation services, and sensor nodes need to be developed accordingly. An applications service, such as a national defense boundary observation service, is a real-time service used by a large number of soldiers, and thus is formed of a massive amount of sensor nodes. Delay in data delivery in such a sensor network formed of a massive amount of sensor nodes may have fatal consequences in such an application service sensitive to delay. Also, real-time services must quickly recognize an object, and transmit recognition information to a command control unit over a long distance.

In order to realize such a national defense boundary observation service in real-time in a sensor network, a routing mechanism guaranteeing no service delay is required. Packet delay in a ubiquitous sensor network (USN) may be delayed in a node itself or delayed in packet transmission between nodes. However, only short hop counts are used to minimize delay. However, when quality of a link is low, delay may increase due to retransmission, even when hop counts are short. Accordingly, a real-time service that guarantees no service delay may be processed, when quality of a link between nodes and packet delay time in the nodes are guaranteed.

According to the Spatiotemporal Communication Protocol for Sensor Networks (SPEED), which is a document about real-time routing, SPEED performs geographic location based routing. According to SPEED, a required transmission speed is maintained by combining backpressure rerouting and nondeterministic techniques. When congestion is generated in any one route distributed based on a predetermined uniform speed, packets around a large-delay link are re-routed. Also, so as to usefully use a bandwidth, which is a characteristic of a sensor network, or a small energy resource, SPEED simultaneously has various routes, thereby using nondeterministic forwarding for load balancing of each flow. As such, although SPEED requires real-time routing, a delay occurs during a real service, as SPEED tries re-routing when congestion or a void region that cannot be reached occurs. Also, since SPEED uses load balancing despite it being a sensor network with insufficient resources, a lot of resources may be wasted by setting several paths to one destination. Accordingly, it is important to select a route wherein congestion may not occur, and preferentially transmitting an important packet for real-time application must be considered.

Conventional Materialized In Network Top-k (MINT) routing is a routing metric using the quality of a link, and uses an exponentially weighted moving average (EWMA) method, which calculates values of the quality of a newly predicted link and the quality of a pre-predicted link by using weight control. However, since the conventional MINT routing uses non-linear link prediction, information about the quality of a link is not sufficient to determine an excellent routing path. As described above, the MINT routing is fatal in a real-time application as it cannot sufficiently reflect the quality and status of a current link. Moreover, many links are lossy in terms of the entire sensor network, and the loss rate dynamically changes according to environments. As such, re-transmission in a link level is fatal for reliable transmission, and in order to compensate such a lossy channel, each hop may require at least one re-transmission. This at least one re-transmission may have a large effect on the delay of data transmission in a real-time service. Accordingly, when a node selects a next hop for a packet, information about a current status of a neighboring link must be known so as to determine a better path.

### SUMMARY OF THE INVENTION

The present invention provides an apparatus and method of transmitting a packet of a node in a wireless sensor network, which minimizes a delay of a packet that requires real-time transmission by preferentially processing the packet that requires real-time transmission by using priority queues, and realizes reliable routing by avoiding a node that generates congestion during routing by obtaining queue information of a neighboring node.

According to an aspect of the present invention, there is provided an apparatus for transmitting a packet of a node in a wireless sensor network, the apparatus including: a plurality of priority queues; a storage controlling unit which stores packets, which are to be transmitted to neighboring nodes within a wireless reception range of the node, in corresponding priority queues according to a transmission priority of the packets from among the plurality of priority queues; and a packet transmitting unit which transmits the packets stored in each of the plurality of priority queues, according to a priority of each of the plurality of priority queues.

According to another aspect of the present invention, there is provided a method of transmitting a packet of a node having a plurality of priority queues in a wireless sensor network, the method including: storing packets, which are to be transmitted to neighboring nodes within a wireless reception range of the node, in corresponding priority queues according to a transmission priority of the packets from among the plurality of priority queues; and transmitting the packets stored in each of the plurality of priority queues according to a priority of the each of the plurality of priority queues.

According to another aspect of the present invention, there is provided an apparatus for transmitting a packet of a node in a wireless sensor network having a hierarchical tree structure, the apparatus including: a neighboring information collecting unit which collects information about a load of a queue for storing packets of each of neighboring nodes from packets received from the neighboring nodes within a wireless reception range of the node; a parent node selecting unit which selects a parent node to which a sensor data packet that requires real-time transmission is to be routed from among the neighboring nodes, based on the collected information; and a data transmitting unit which transmits the sensor data packet to the selected parent node.

According to another aspect of the present invention, there is provided a method of transmitting a packet of a node in a wireless sensor network having a hierarchical tree structure, the method including: collecting information about a load of a queue for storing packets of each of neighboring nodes from packets received from the neighboring nodes within a wireless reception range of the node; selecting a parent node to which a sensor data packet that requires real-time transmission is to be routed from among the neighboring nodes, based on the collected information; and transmitting the sensor data packet to the selected parent node.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a hierarchical wireless sensor network for a massive sensor network, according to an embodiment of the present invention;

FIG. 2 is a diagram illustrating an apparatus for transmitting a packet of a node in a wireless sensor network, according to an embodiment of the present invention;

FIG. 3 is a flowchart of a method of transmitting a packet, performed in an apparatus for transmitting a packet of a node in a wireless sensor network, according to an embodiment of the present invention;

FIG. 4 is a diagram for describing a process of processing a packet in an apparatus for transmitting a packet of a node in a wireless sensor network, according to an embodiment of the present invention;

FIGS. 5A and 5B are tables showing priority levels regarding packet transmission and corresponding packet types, according to an embodiment of the present invention;

FIG. 6 is a diagram illustrating a process of controlling transmission of packets stored in each priority queue, in an apparatus for transmitting a packet of a node, according to an embodiment of the present invention;

FIG. 7 is a diagram illustrating an apparatus for transmitting a packet of a node in a wireless sensor network, according to another embodiment of the present invention;

FIG. 8 is a flowchart of a method of transmitting a packet, performed in an apparatus for transmitting a packet of a node in a wireless sensor network, according to another embodiment of the present invention;

FIG. 9 is a diagram illustrating processes of collecting information about a load of a queue of each neighboring node and transmitting the information to a corresponding parent node, in an apparatus for transmitting a packet of a node in a wireless sensor network, according to an embodiment of the present invention.

FIG. 10 is a diagram illustrating a process of selecting a parent node in an apparatus for transmitting a packet of a node in a wireless sensor network, according to an embodiment of the present invention.

### DETAILED DESCRIPTION OF THE INVENTION

Hereinafter, only principles of the present invention are described. Accordingly, although not clearly described or illustrated, one of ordinary skill in the art will be able to realize the principles of the present invention and embody various apparatuses including the concept and range of the present invention. Terminologies and embodiments used to describe the present invention are for illustrative purposes only and are not intended to limit the scope of the invention. Also, the detailed descriptions about the principles, point of views, and embodiments of the present invention are intended to include corresponding structural and functional equivalents. Such equivalents not only include well known equivalents but also equivalents that are to be developed in the future, i.e. all devices manufactured to perform the same function regardless of structure.

Accordingly, functions of various devices illustrated in drawings including a processor or a functional block illustrated in a concept similar to a processor may be provided by using exclusive hardware or by using hardware having a capability to execute software. When the functions are provided by a processor, the functions may be provided by a single exclusive processor, a single shared processor, or a plurality of separate processors, wherein some separate processors share functions.

Also, a processor, control, or a terminology used in a similar concept is not to be interpreted by exclusively referring to hardware having a capability to execute software, but is understood to limitlessly include digital signal processor (DSP) hardware, ROM for storing software, RAM, and a nonvolatile memory. Other well known hardware may be included as well.

Also, while describing the present invention, detailed descriptions about related well-known technologies that may diminish the clarity of points of the present invention are omitted. Hereinafter, the present invention will be described more fully with reference to the accompanying drawings, in which exemplary embodiments of the invention are shown.

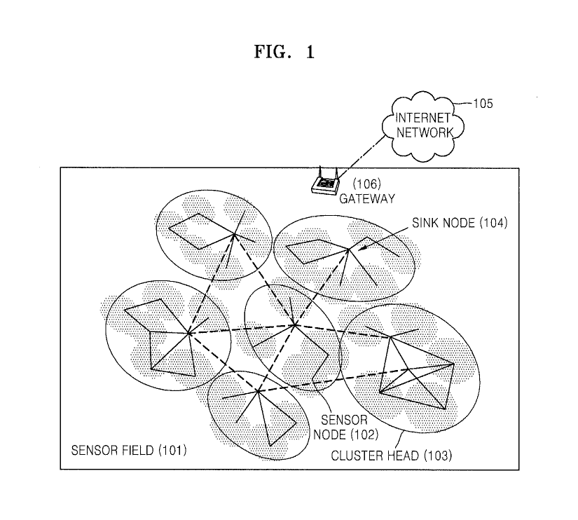

FIG. 1 is a diagram illustrating a hierarchical wireless sensor network for a massive sensor network, according to an embodiment of the present invention.

A sensor field 101 of the wireless sensor network according to the current embodiment includes a sensor node 102, a cluster head 103, and a gateway 106.

The sensor node 102 collects sensor data from a sensor (not shown).

In order to reduce an error probability of sensor information collected from the sensor node 102 of a corresponding cluster (not shown), the cluster head 103 performs a data processing process, such as filtering or combining the sensor data, and then transmits the sensor data to a sink node 104, or alternatively, transmits information received from the sink node 104 or from another cluster head 103 to a node in a cluster.

The sink node 104 of the current embodiment denotes one of the cluster heads 103 that transmits data of the sensor field 101 to the gateway 106, while transmitting the data of the sensor field 101 to an external network.

The cluster head 103 or the sink node 104 may be configured to perform functions of a sensor node or a cluster head, according to a type of real-time service.

The sensor node 102 performing a sensing function transmits sensed information to the cluster head 103 via a mesh network, and then the cluster head 103 transmits the received sensed information to the gateway 106 via the mesh network.

The gateway 106 is a system connecting the wireless sensor network and an external internet network 105, and transmits information collected by the sensor of the wireless sensor network to a distant task manager that requires real-time information via the external internet network 105 or another network.

According to the wireless sensor network having such a hierarchical structure, data is only delayed a little by remarkably reducing hop counts of a packet, and thus transmission performance is increased compared to a conventional flat structure, and delay in a massive network is reduced.

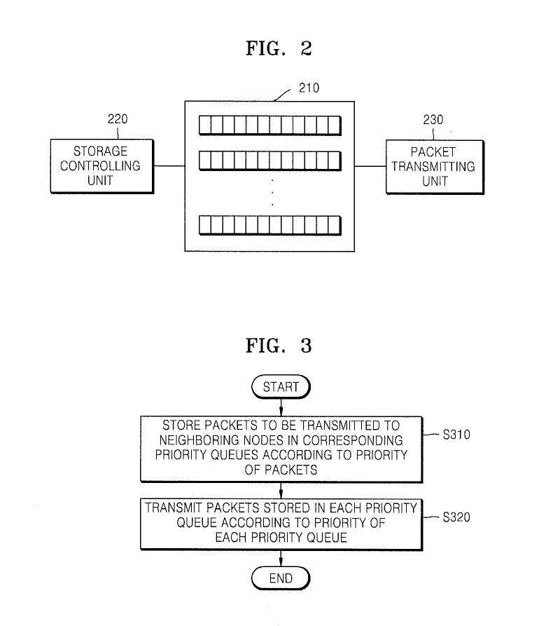

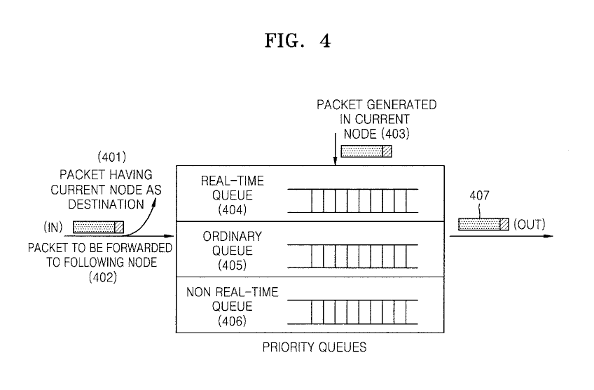

FIG. 2 is a diagram illustrating an apparatus for transmitting a packet of a node in a wireless sensor network, according to an embodiment of the present invention. FIG. 3 is a flowchart of a method of transmitting a packet, performed in the apparatus of FIG. 2.

Referring to FIG. 2, the apparatus according to the current embodiment includes a plurality of priority queues 210, a storage controlling unit 220, and a packet transmitting unit 230.

The plurality of priority queues 210 are spaces for storing packets to be transmitted to neighboring nodes, and the storage controlling unit 220 stores the packets to be transmitted to the neighboring nodes in each of the priority queues 210 according to a priority of the packets in operation S310,

In operation S320, the packet transmitting unit 230 transmits the packets stored in each of the priority queues according to priority of each of the priority queues.

FIG. 4 is a diagram for describing a process of processing a packet in an apparatus for transmitting a packet of a node in a wireless sensor network, according to an embodiment of the present invention.

Referring to FIG. 4, a packet transmitted to a node may be a packet 401 having a current node as a destination and a packet 402 to be forwarded to a following node. Here, the packet 402 is stored in a priority queue, and also, a packet 403 generated in the current node is stored in the priority queue.

A node according to the current embodiment includes three priority queues, i.e. a real-time queue 404, an ordinary queue 405, and a non real-time queue 406. The real-time queue 404 stores a packet that requires real-time transmission, the ordinary queue 405 stores a packet that requires ordinary time transmission, and the non-real-time queue 406 stores a packet that does not require real-time transmission.

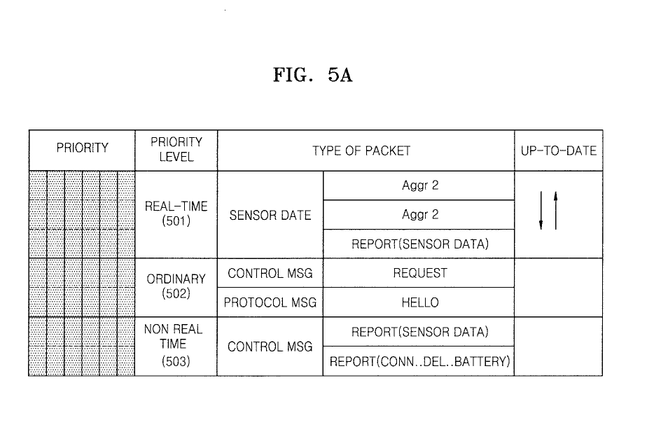

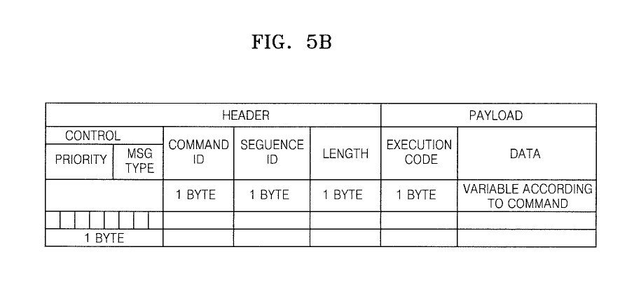

FIGS. 5A and 5B are tables showing priority levels regarding packet transmission and corresponding packet types, according to an embodiment of the present invention.

Referring to FIGS. 5A and 5B, the highest priority level is a real-time level 501, and sensor data may have the real-time level 501. In other words, data measured by a sensor and data that is primarily or secondarily combined while transmitting data to a sink node may have the real-time level 501.

An ordinary level 502 is an intermediate priority level, and a control message or a protocol message as a sensor network control packet has the ordinary level 402. A non real-time level 503 is the lowest priority level, and a packet that is not affected in real-time has the non real-time level 503. The packet having the non real-time level 503 may be a response according to a request of an external task manager or a periodical report.

In the current embodiment, information about a priority of a packet is stored in a header of the packet, and thus a node that received the packet obtains the information about the priority of the packet.

Referring back to FIG. 2, the apparatus may further include a neighboring information collecting unit (not shown). The neighboring information collecting unit collects information about a load of a queue of each neighboring node from packets received from neighboring nodes within a wireless reception range of the node.

In this case, the packet transmitting unit 230 includes a transmission controlling unit, which controls transmission of packets stored in each priority queue based on the information collected by the neighboring information collecting unit. The transmission controlling unit discards packets stored in some priority queues having low priority or controls a packet rate by controlling a scheduling time, based on the information about the load of the queue of each neighboring node.

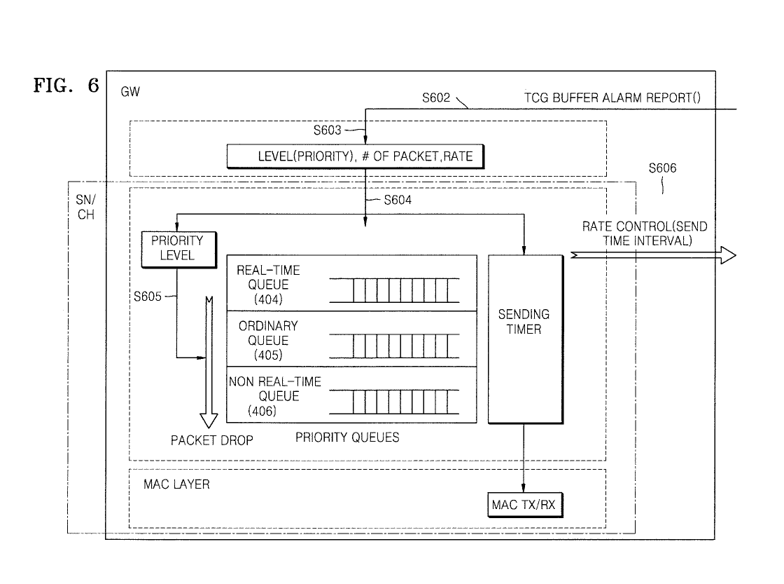

FIG. 6 is a diagram illustrating a process of controlling transmission of packets stored in each priority queue, in an apparatus for transmitting a packet of a node, according to an embodiment of the present invention.

A sensor node (SN) and a cluster head (CH) in a sensor network preferentially transmits a packet stored in a real-time queue 404 according to priority of packets to a neighboring node via a media access control (MAC) layer.

When a gateway (GW) of the sensor network receives a message notifying a traffic load status from an external interlocking device that combines GWs of each sensor network in operation S602, an application layer of the GW analyzes the message in operation S603, and transmits the load status to a network layer in operation S604.

After recognizing the load status, the SN, the CH, and the network layer of the GW may discard packets having low priority in operation S605 when required, so as to decrease the traffic load. However, there is a limit to discarding packets, and even when packets in an ordinary queue 405 and a non real-time queue 406 are all discarded, the packets stored in the real-time queue 404 cannot be discarded. Thus, an overload in an upper node may not be resolved until the packets stored in the real-time queue 404 are all transmitted. In this case, the MAC layer controls a scheduling time of a channel so as to control transmission of packets in operation S606, and thus an overload is prevented by controlling a packet rate of transmitting the packets.

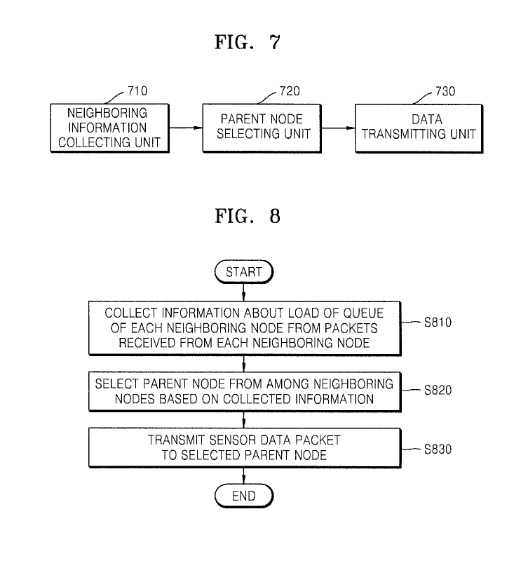

FIG. 7 is a diagram illustrating an apparatus for transmitting a packet of a node in a wireless sensor network, according to another embodiment of the present invention. FIG. 8 is a flowchart of a method of transmitting a packet, performed in the apparatus of FIG. 7.

Referring to FIG. 7, the apparatus includes a neighboring information collecting unit 710, a parent node selecting unit 720, and a data transmitting unit 730.

The neighboring information collecting unit 710 collects information about a load of a queue storing packets of each neighboring node, from the packets received from the neighboring nodes in operation S810.

The parent node selecting unit 720 selects a parent node to which a sensor data packet that requires real-time transmission is to be routed from the neighboring nodes, based on the collected information in operation S820. While selecting the parent node, a well known expected number of transmissions through links, according to a cost metric for routing, may be used aside from the collected information. In other words, the parent node is selected in such a way that the number of times a packet is transmitted on a multi-hop to a destination is minimized via the optimum path without almost any retransmission. The optimum path has almost no retransmission since reliability of links of the optimum path is high due to the maintenance of not only the information about the collected information about also information about a status of the links.

The data transmitting unit 730 transmits the sensor data packet to the parent node selected by the parent node selecting unit 720 in operation S830.

The data transmitting unit 730 may control transmission of the sensor data packet like the packet transmitting unit 230 of FIG. 2, based on the collected information. In other words, an MAC layer controls transmission of the sensor data packet by controlling a scheduling time of a channel, thereby controlling a packet rate of the sensor data packet.

The apparatus according to the current embodiment may include a plurality of priority queues like the apparatus of FIG. 2, and in this case, the apparatus may further include a piggybacking unit (not shown) which piggybacks information about a load of a real-time queue storing sensor data that requires real-time transmission onto packets to be transmitted to the neighboring nodes.

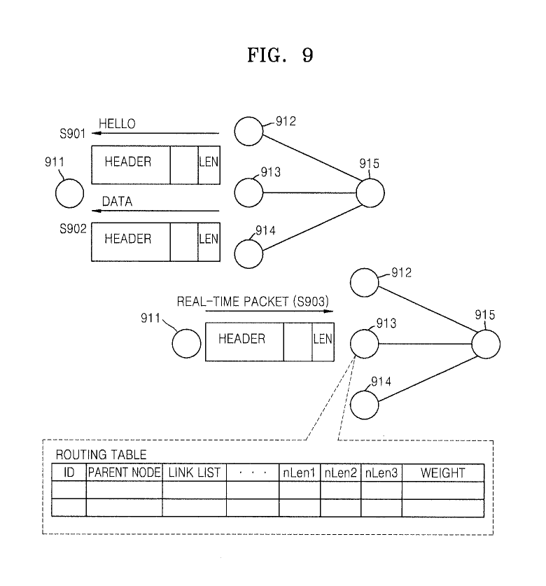

FIG. 9 is a diagram illustrating processes of collecting information about a load of a queue of each neighboring node and transmitting the information to a corresponding parent node, in an apparatus for transmitting a packet of a node in a wireless sensor network, according to an embodiment of the present invention.

It is essential to select a parent node that has a low load while routing a packet, so as to avoid congestion in the parent node.

Referring to FIG. 9, a current node 911 receives a Hello message from neighboring nodes 912 through 914 in operation S901 or obtains information about loads of queues of the neighboring nodes 912 through 914 piggybacked onto a data message in operation S902. Also, information about a real-time queue of the current node 911 is piggybacked onto a control message transmitted to the neighboring nodes 912 through 915 or onto a real-time data message transmitted to a parent node selected from among the neighboring nodes 912 through 915 to be transmitted to the neighboring nodes 912 through 915 in operation S903, and thus real-time transmission is performed in each node in the wireless sensor network.

Each node in the wireless sensor network stores information about queues of neighboring nodes in a routing table and determines whether to reduce the size of a queue, based on the received piggybacked information.

Each of nLen1, nLen2, and nLen3 fields in a routing table of FIG. 9 stores information about queue sizes of each of the neighboring nodes 912 through 914, and a weight field stores a weight value regarding size reduction of a queue.

For example, the current node 911 compares a weight value and a threshold value, and when the weight value is bigger than the threshold value, the current node 911 may reduce the size of the real-time queue.

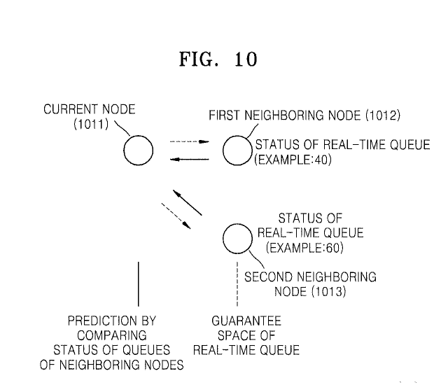

FIG. 10 is a diagram illustrating a process of selecting a parent node in an apparatus for transmitting a packet of a node in a wireless sensor network, according to an embodiment of the present invention.

Referring to FIG. 10, a current node 1011 collects information about queues of each of first and second neighboring nodes 1012 and 1013, recognizes that a load of a real-time queue of the first neighboring node 1012 is lower than a load of a real-time queue of the second neighboring node 1013, and selects the second neighboring node 1013 as a parent node.

According to the present invention, a packet that requires real-time transmission is preferentially processed by controlling priority queues storing packets of each node in a wireless sensor network, thereby minimizing a delay of the packet that requires real-time transmission, and realizing real-time data transmission for a monitoring boundary application.

Each node can predict a node load by obtaining information about a queue status of neighboring nodes from packets received from the neighboring nodes. A parent node prevents congestion by pre-obtaining a queue space for a real-time packet based on information about a queue status of a child node, and a child node can avoid a node becoming congested while selecting a parent node. Accordingly, the child node can transmit a packet that requires real-time transmission without any delay.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The font ROM data structure according to the present invention may also be embodied as computer readable codes on a computer readable recording medium, such as ROM, RAM, CD-ROM, a magnetic tape, a hard disk, a floppy disk, a flash memory, an optical data storage device, or the like.

While this invention has been particularly shown and described with reference to preferred embodiments thereof, it will be understood by one of ordinary skill in the art that various changes in form and details may be made therein without departing from the spirit and scope of the invention as defined by the appended claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for transmitting a packet of a node in a wireless sensor network, the apparatus comprising:
a plurality of priority queues;
a storage controlling unit which stores packets, which are to be transmitted to neighboring nodes within a wireless reception range of the node, in corresponding priority queues according to a transmission priority of the packets from among the plurality of priority queues; and
a packet transmitting unit which transmits the packets stored in each of the plurality of priority queues, according to a priority of each of the plurality of priority queues.

2. The apparatus of claim 1, further comprising a neighboring information collecting unit which collects information about a load of a queue of each of the neighboring nodes from packets received from the neighboring nodes within the wireless reception range of the node,
wherein the packet transmitting unit comprises a transmission controlling unit which controls transmission of the packets stored in each of the plurality of the priority queues, based on the collected information.

3. The apparatus of claim 2, wherein the transmission controlling unit discards packets stored in some priority queues having low priority from among the plurality of priority queues, based on the collected information.

4. The apparatus of claim 2, wherein the transmission controlling unit controls a packet rate by controlling a scheduling time, based on the collected information.

5. The apparatus of claim 1, wherein a sensor data packet that requires real-time transmission from among the packets has the highest transmission priority.

6. A method of transmitting a packet of a node having a plurality of priority queues in a wireless sensor network, the method comprising:
storing packets, which are to be transmitted to neighboring nodes within a wireless reception range of the node, in corresponding priority queues according to a transmission priority of the packets from among the plurality of priority queues; and
transmitting the packets stored in each of the plurality of priority queues according to a priority of the each of the plurality of priority queues.

7. The method of claim 6, further comprising, before the transmitting of the packets: collecting information about a load of a queue of each of the neighboring nodes from packets received from the neighboring nodes within the wireless reception range of the node,
wherein the transmitting of the packets comprises controlling transmission of the packets stored in each of the plurality of priority queues, based on the collected information.

8. The method of claim 7, wherein the controlling of the transmission comprises discarding packets stored in some priority queues having low priority from among the plurality of priority queues, based on the collected information.

9. The method of claim 7, wherein the controlling of the transmission comprises controlling a packet rate by controlling a scheduling time, based on the collected information.

10. The method of claim 6, wherein a sensor data packet that requires real-time transmission from among the packets has the highest transmission priority.

11. An apparatus for transmitting a packet of a node in a wireless sensor network having a hierarchical tree structure, the apparatus comprising:
a neighboring information collecting unit which collects information about a load of a queue for storing packets of each of neighboring nodes from packets received from the neighboring nodes within a wireless reception range of the node;
a parent node selecting unit which selects a parent node to which a sensor data packet that requires real-time transmission is to be routed from among the neighboring nodes, based on the collected information; and
a data transmitting unit which transmits the sensor data packet to the selected parent node.

12. The apparatus of claim 11, further comprising a plurality of priority queues which store packets to be transmitted from the node to the neighboring nodes.

13. The apparatus of claim 12, further comprising a piggybacking unit which piggybacks information about a load of a queue for storing the sensor data packet from among the plurality of priority queues onto the packets to be transmitted to the neighboring nodes.

14. The apparatus of claim 12, wherein the data transmitting unit comprises a transmission controlling unit which controls transmission of the sensor data packet based on the collected information.

15. A method of transmitting a packet of a node in a wireless sensor network having a hierarchical tree structure, the method comprising:
collecting information about a load of a queue for storing packets of each of neighboring nodes from packets received from the neighboring nodes within a wireless reception range of the node;
selecting a parent node to which a sensor data packet that requires real-time transmission is to be routed from among the neighboring nodes, based on the collected information; and
transmitting the sensor data packet to the selected parent node.

16. The method of claim 15, further comprising piggybacking information about a load of a queue for storing the sensor data packet onto the packets to be transmitted to the neighboring nodes.

17. The method of claim 15, wherein the transmitting of the sensor data packet comprises controlling the sensor data packet based on the collected information.
